(19) United States
(12) Patent Application Publication
(10) Pub. No.: US 2004/0126519 A1
(43) Pub. Date: Jul. 1, 2004

(54) Solids-entrapping secondary article

(76) Inventors: Thomas W. Odorzynski, Green Bay, WI (US); Linda K. Lemerande, Waupaca, WI (US)

Correspondence Address: KIMBERLY-CLARK WORLDWIDE, INC., 401 NORTH LAKE STREET, NEENAH, WI, 54956

(21) Appl. No.: 10/334,804

(22) Filed: Dec. 31, 2002

(51) Int. Cl. B32B 1/02

(52) U.S. Cl. 428/35.2; 428/36.5; 428/36.4

(57) ABSTRACT

A disposable, solids-entrapping secondary article includes a liquid-permeable pad having a body-facing surface. The body-facing surface of the pad defines an opening providing access to an internal void defined within the pad. The internal void is sized and positioned within the pad to collect and retain solid wastes. Optionally, the secondary article further includes a liquid-permeable body-side liner. The body-side liner defines an opening that aligns with the opening defined in the body-facing surface of the pad to permit passage of solid waste material through the body-side liner and into the internal void of the pad. The solids-entrapping secondary article of the present invention reduces contact between solid wastes and the skin of the wearer, and presents a drier body-facing surface to the skin of the wearer.

### BACKGROUND OF THE INVENTION

The present invention generally relates to secondary articles for use in conjunction with primary absorbent products such as diapers, incontinence products and the like. More particularly, the present invention relates to secondary articles useful when there is a need to promote skin dryness and to inhibit solid fecal matter from contacting the skin.

Primary absorbent products such as disposable diapers, incontinence products and the like are designed to provide absorbent capacity for bodily fluids and containment of solid fecal matter. It is generally desired that these products be as thin and form fitting as possible to minimize package space on store shelves and be as inconspicuous as possible during use. However, it has long been known that skin health is enhanced by keeping the skin dry and minimizing contact of the skin with solid fecal matter, an objective that may conflict with the objective of making primary absorbent products small, thin, and form fitting. Thus, there is a need for a secondary article that can be used in conjunction with a primary absorbent product that promotes skin dryness and that inhibits solid fecal matter from contacting the skin of the wearer.

### SUMMARY OF THE INVENTION

The aforementioned needs for a disposable secondary article are addressed by the present invention which provides a solids-entrapping secondary article. In one aspect of the present invention, the secondary article includes a liquid-permeable pad having a body-facing surface. The body-facing surface of the pad defines an opening providing access to an internal void defined within the pad. The internal void is sized and positioned within the pad to collect and retain solid wastes. In one embodiment, the shape of the secondary article is rectangular. In another embodiment, the length of the secondary article is less than about 500 millimeters. In a further embodiment, the width of the secondary article is less than about 150 millimeters. In an even further embodiment, the height of the secondary article is less than about 30 millimeters.

Desirably, the pad is resilient to z-directional compression. Examples of suitable pad materials include, but are not limited to foams, crimped fibers, multicomponent fibers, and so forth. In one embodiment, the pad includes a three-dimensional fiber network comprising compressible projections, wherein the compressible projections return substantially to their original shape after being compressed. In another embodiment, the pad includes more than one layer. In a further embodiment, the pad is substantially nonabsorbent.

Desirably, the volume of the internal void defined within the pad is greater than about 5 cm³. Desirably, the cross-sectional area of the opening defined in the body-facing surface of the pad that provides access to the internal void is greater than about 2 cm². In one embodiment, the pad further includes at least two fingers extending into the internal void defined within the pad.

In a further aspect of the invention, the secondary article further includes a liquid-permeable body-side liner. The body-side liner defines an opening that aligns with the opening defined in the body-facing surface of the pad to permit passage of solid waste material through the body-side liner and into the internal void of the pad. Suitably, the body-side liner is spunbond material. Desirably, the cross-sectional area of the opening defined in the body-side liner is greater than about 2 cm². Desirably, the cross-sectional area of the opening defined in the body-side liner is larger than the cross-sectional area of the opening defined in the body-facing surface of the pad.

In a further aspect of the invention, the secondary article further includes an attachment means adapted to attach the secondary article to a primary absorbent article.

In another aspect, the present invention includes an absorbent system that includes a primary absorbent article having a target zone for receiving waste. A solids-entrapping secondary article is attached to the primary absorbent article. The solids-entrapping secondary article includes a liquid-permeable pad having a body-facing surface. The body-facing surface of the pad defines an opening providing access to an internal void defined within the pad. The opening and internal void are sized to collect and retain solid wastes, and the opening and internal void are positioned within the target zone of the primary absorbent article. Desirably, the pad is resilient to z-directional compression.

In a further aspect, the secondary article of the absorbent system further includes a liquid-permeable body-side liner. The body-side liner defines an opening that aligns with the opening defined in the body-facing surface of the pad to permit passage of solid waste material through the body-side liner and into the internal void of the pad.

In a further aspect, the solids-entrapping secondary article is substantially the same shape as the primary absorbent article.

Other features and aspects of the present invention are discussed in greater detail below.

### BRIEF DESCRIPTIONS OF THE DRAWINGS

FIG. 1 is a top view of a solids-entrapping secondary article.

FIG. 2 is a cross-sectional view of the secondary article shown in FIG. 1 taken along line 2-2.

FIG. 3 is a bottom view of the secondary article shown in FIG. 1.

FIG. 4 is a perspective view of another embodiment of a solids-entrapping secondary article.

FIG. 5 is a perspective view of the solids-entrapping secondary article positioned in the crotch portion of a primary absorbent product.

FIG. 6 is a cross-sectional view of the combination secondary article and primary absorbent product shown in FIG. 5 taken along line 5-5.

### DETAILED DESCRIPTION

The invention will now be described in detail with reference to particular embodiments thereof. The embodiments are provided by way of explanation of the invention, and not meant as a limitation of the invention. For example, features described or illustrated as part of one embodiment may be used with another embodiment to yield still a further embodiment. It is intended that the present invention include these and other modifications and variations as come within the scope and spirit of the invention.

As used herein and in the claims, the term “comprising” is inclusive or open-ended and does not exclude additional unrecited elements, compositional components, or method steps. Accordingly, the term “comprising” encompasses the more restrictive terms “consisting essentially of” and “consisting of.”

The present invention provides a disposable secondary article for use in combination with a primary absorbent product such as a disposable diaper. As used herein, the term “disposable” refers to articles which are intended to be discarded after a limited use and that are not intended to be laundered or otherwise restored for reuse. The disposable secondary article includes a resilient, three-dimensional pad that provides internal voids designed to accept and retain solid fecal matter. By having the solid fecal matter enter the internal voids of the secondary article, skin contact with the fecal matter is reduced.

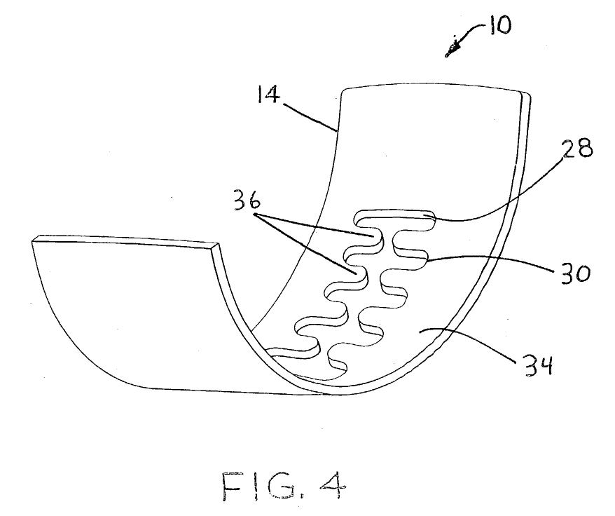

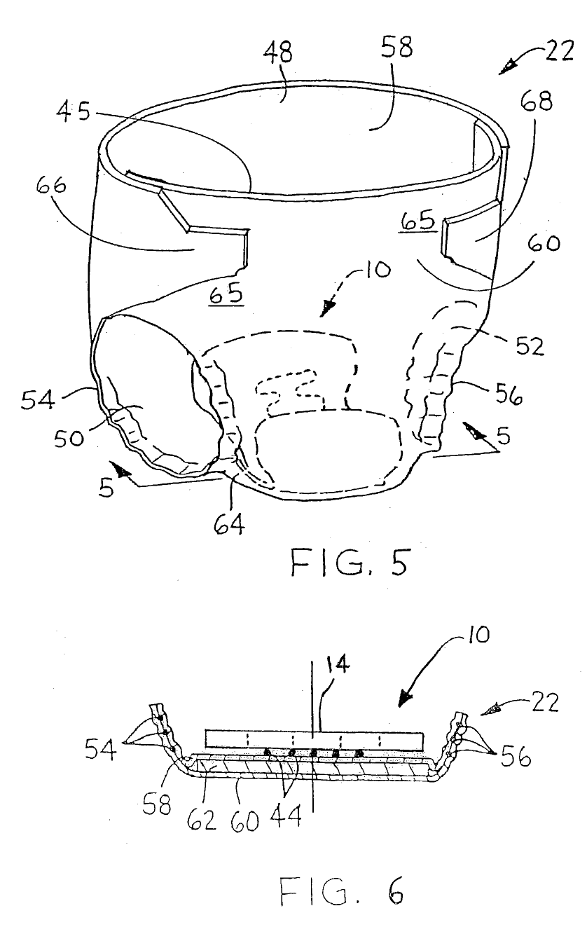

Referring to FIGS. 1-4, a disposable secondary article 10 is shown constructed of a pad 14 defining one or more internal voids 28, an optional body-side liner 16, and one or more optional attachment means 44. Optionally, the secondary article 10 may have a crotch portion 20 that fits between the legs in the crotch region of the wearer. The secondary article 10 is an elongated member having a longitudinal axis x-x, a transverse axis y-y and a vertical axis z-z. The secondary article 10 can have a rectangular, hourglass, racetrack, oval, elliptical, I-shape, T-shape or other geometrical configuration when viewed from the top. The secondary article 10 has an overall length measured parallel to the longitudinal axis x-x. In some embodiments, the secondary article 10 has an overall length of less than about 600 millimeters (mm). In other embodiments, the secondary article 10 may have an overall length of less than about 500 mm, less than about 400 mm, less than about 300 mm, or less than about 200 mm. The secondary article 10 also has a crotch width measured parallel to the transverse axis y-y. In some embodiments, the secondary article 10 has a crotch width of less than about 200 mm. In other embodiments, the crotch width of the secondary article 10 may be less than about 175 mm, less than about 150 mm, less than about 125 mm, less than about 100 mm, or less than about 75 mm. It should be noted that the secondary article 10 could have a wider width when measured away from the crotch portion. The secondary article 10 also has an overall height measured parallel to the vertical axis z-z. In some embodiments, the overall height may be from about 5 mm to about 30 mm. In other embodiments, the secondary article 10 may have a height of from about 10 mm to about 30 mm, from about 15 mm to about 30 mm, from about 20 mm to about 30 mm, or from about 25 mm to about 30 mm. Desirably, the secondary article 10 is sized to fit within the target zone of a primary absorbent article 22, see FIG. 5. It is apparent that the dimensions of the secondary article 10 desirably properly correspond to the size of the intended wearer and the size of the corresponding primary absorbent article 22. All of the above lengths, widths, and height dimensions are measured with respect to the pad 14.

When not covered by the optional body-side liner 16, the pad 14 suitably presents a bodyfacing surface that is compliant, soft feeling, and nonirritating to the skin of the wearer. The pad 14 can be constructed from natural or synthetic material. The pad 14 can be formed from a woven material, nonwoven material, finely perforated film, net material, porous foams, reticulated foams, and so forth. Suitable materials include but are not limited to fibrous materials such as bonded carded webs, meltblown fabrics, and spunbond fabrics. Suitable fibers include but are not limited to polyester, polypropylene, polyethylene, nylon or other heat-bondable fibers. Other polyolefins, such as copolymers of polypropylene and polyethylene, and linear low-density polyethylene also work well.

Desirably, the pad 14 is a high loft, low density material so as to provide greater thickness at lower basis weights. The pad 14 can be formed from materials having a range of basis weights depending on the density of the material. For example, a lower density material will not require as high a basis weight for a particular thickness. Also, the pad 14 can consist of one or more layers to provide greater thickness or height to the pad 14. Greater thickness provides more void volume, more room for containing the solid waste material, and less contact of the solid waste material with the skin of the wearer.

Desirably, the pad 14 may be highly resilient to z-directional compression to avoid compression of the pad 14 and reduction in size of the internal voids 28. Nonwoven materials formed from crimped multicomponent fibers are known to provide high loft and high z-directional resilience. The production of crimped multicomponent fibers for nonwoven materials is described, for example, in Pike, et al., U.S. Pat. No. 5,382,400 and Neely et al., U.S. Pat. No. 5,454,142, the entire contents of these patents being incorporated herein by reference.

Another example of a material useful as the pad 14 includes three-dimensional fiber networks made from textile fabrics that have projections and optional depressions which are compressible and return substantially to their original shape after being depressed. Materials of this type are described, for example, in Kim et al., U.S. Pat. No. 5,731,062, the entire contents of this patent being incorporated herein by reference. Such material is a synthetic thermoplastic fiber network in flexible sheets having projections and/or indentations for use as cushions and/or impact-absorbing components. These fiber networks are typically made by thermo-mechanical deformation of textile fabrics that are made from thermoplastic fibers. In accordance with the present invention other types of materials with individual spring or spring-like protrusions may be used as the pad 14. Additionally, other materials which may provide the high loft, low density, and high z-directional resilience desirable for the pad 14 include, but are not limited to open cell foamed materials.

The pad 14 should be liquid and vapor permeable to allow bodily fluids, especially urine expelled voluntarily or involuntarily from the urethra, which come into contact with the pad 14 to easily penetrate therethrough and be received by a primary absorbent article. By “liquid and vapor permeable” it is meant that body fluids, especially urine, and vapors can pass therethrough. The pad 14 helps to isolate the skin of the wearer from liquids held in a primary absorbent product and the solids held within the internal voids 28 of the pad 14. The pad 14 can be constructed with pores or openings that permit liquids and vapors to pass therethrough. The pad 14 is desirably sufficiently porous to permit liquid and vapor to readily penetrate through its thickness. Additionally and/or alternatively, the material from which the pad 14 is constructed can be treated to be hydrophilic. A suitable treatment includes, but is not limited to, treatment with a surfactant commercially available from Uniqema Inc., a division of ICI of New Castle, Del., U.S.A., under the trade designation AHCOVEL Base N-62. The surfactant may be applied by any conventional means, such as spraying, printing, brush coating or the like. The surfactant may be applied to the entire pad 14 or may be selectively applied to particular sections of the pad 14, such as along the longitudinal centerline of the secondary article 10, to provide greater wettability of such sections.

While the pad 14 may be liquid and vapor permeable, porous, or hydrophilic, the pad 14 is desirably substantially nonabsorbent to present a drier body-facing external surface 34 to the skin of the wearer. By nonabsorbent it is meant that liquids are not permanently retained with the pad 14, but rather pass through the pad 14 without remaining therein.

Still referring to FIGS. 1-4, the pad 14 has at least one internal void 28 that has an opening 30 in the body-facing external surface 34 of the pad 14 to accept and retain solid wastes excreted by the wearer. The size of the internal void 28 is sufficient to hold a quantity of solid waste in accordance with the size of the wearer. For example, the volume of the internal void 28 may be greater than about 5 cm³, greater than about 10 cm³, greater than about 20 cm³, greater than about 30 cm³, greater than about 40 cm³, or greater than about 50 cm³. The size of the opening 30 is sufficiently large to pass solid waste in accordance with the size of the wearer. The cross-sectional area of the opening 30 may be, for example, greater than about 2 cm², greater than about 4 cm², greater than about 6 cm², greater than about 10 cm², greater than about 15 cm², or greater than about 20 cm². The opening 30 and the internal void 28 may be of any shape, for example, round, square, rectangular, and so forth. A desirable shape is depicted in FIGS. 1-4 in which fingers 36 extend into the internal void 28. The fingers 36 provide support to inhibit collapse of the pad 14 that would cause reduction in the size of the internal void 28 and increase contact of the solid waste with the skin of the wearer. Other desirable shapes for the opening 30 and the internal void 28 include star shapes having radial arms that extend into the internal void 28 to inhibit collapse of the pad 14 and the internal void 28. It is to be noted however, that the opening 30 and the internal void 28 do not have to have the same shape.

The pad 14 may have any suitable shape. For example, the pad 14 may be rectangular, hourglass, racetrack, oval, elliptical, I-shaped, or T-shaped, and so forth. The length and width of the pad 14 are substantially as described above for the length and width of the secondary article 22. The pad 14 also has a height, measured parallel to the vertical axis z-z, of from about 5 mm to about 25 mm. In some embodiments, the secondary article 10 may have a height of from about 10 mm to about 25 mm, from about 15 mm to about 25 mm, or from about 20 mm to about 25 mm.

Referring to FIGS. 1-3, the pad 14 may be covered with an optional body-side liner 16 that presents a bodyfacing surface 24 that is compliant, soft feeling, and nonirritating to the skin of the wearer and is designed to allow body fluid, particularly urine, and vapor to pass quickly therethrough. The body-side liner 16 can be constructed from natural or synthetic material. The body-side liner can be formed from a woven material, nonwoven material, finely perforated film, net material, porous foams, reticulated foams, and so forth. Suitable materials include but are not limited to fibrous materials such as bonded carded webs, meltblown fabrics, and spunbond fabrics. Suitable fibers include but are not limited to polyester, polypropylene, polyethylene, nylon or other heat-bondable fibers. Other polyolefins, such as copolymers of polypropylene and polyethylene, and linear low-density polyethylene also work well. A desirable material is a spunbond fabric. Spunbond material is a nonwoven material formed, for example, from polypropylene fibers. Spunbond is sold commercially by Kimberly-Clark Corporation having an office at 401 North Lake Street, Neenah, Wis. 54956. The spunbond material can contain from about 1% to about 2% titanium dioxide pigment to give it a clean, white appearance. The production of spunbonded nonwoven webs is illustrated in patents such as Appel, et al., U.S. Pat. No. 4,340,563, Dorschner et al., U.S. Pat. No. 3,692,618; Kinney, U.S. Pat. Nos. 3,338,992 and 3,341,394; Levy, U.S. Pat. No. 3,276,944; Peterson, U.S. Pat. No. 3,502,538; Hartman, U.S. Pat. No. 3,502,763; Dobo et al., U.S. Pat. No. 3,542,615; Matsuki et al., U.S. Pat. No. 3,802,817; and Harmon, Canadian Patent Number 803,714, the entire contents of these patents being incorporated herein by reference.

The body-side liner 16 can be formed from materials having a range of basis weights. When the body-side liner 16 is formed from a spunbond material, the material desirably has a basis weight of from about 10 gsm to about 34 gsm. More desirably, the basis weight of the spunbond material is from about 12 gsm to about 17 gsm.

The body-side liner 16 should be liquid and vapor permeable to allow bodily fluids, especially urine expelled voluntarily or involuntarily from the urethra, which come into contact with the body-side liner 16 to easily penetrate therethrough and be received by the pad 14. The material from which the optional body-side liner 16 is constructed may be treated to be hydrophilic as described above for the pad 14. Additionally and/or alternatively, the body-side liner 16 can be constructed to have pores or openings that permit liquids and vapors to pass through. When the optional body-side liner 16 is used, it is desirable that the liquid permeability of the pad 14 is at least equal to the liquid permeability of the body-side liner 16 to avoid pooling of the liquid within the pad 14.

Still referring to FIGS. 1-3, the optional body-side liner 16 has at least one opening 32 to permit solid wastes to pass through the body-side liner 16 and into the internal void 28 of the pad 14. The size of the opening 32 is sufficiently large to pass solid waste in accordance with the size of the wearer. The cross-sectional area of the opening 32 may be, for example, greater than about 2 cm², greater than about 4 cm², greater than about 6 cm², greater than about 10 cm², greater than about 15 cm², or greater than about 20 cm². The opening 32 may be of any shape, for example, round, square, rectangular, and so forth. In some embodiments, the size of the opening 32 in the body-side liner 16 is smaller than the size of the opening 30 in the pad 14. When the opening 32 in the body-side liner 16 is smaller than the opening 30 in the pad 14, the solid wastes are able to pass through the opening 32 in the body-side liner 16 and into the internal void 28 under the body-side liner 16. Thus, the body-side liner 16 serves as a barrier between the solid waste and the skin of the wearer.

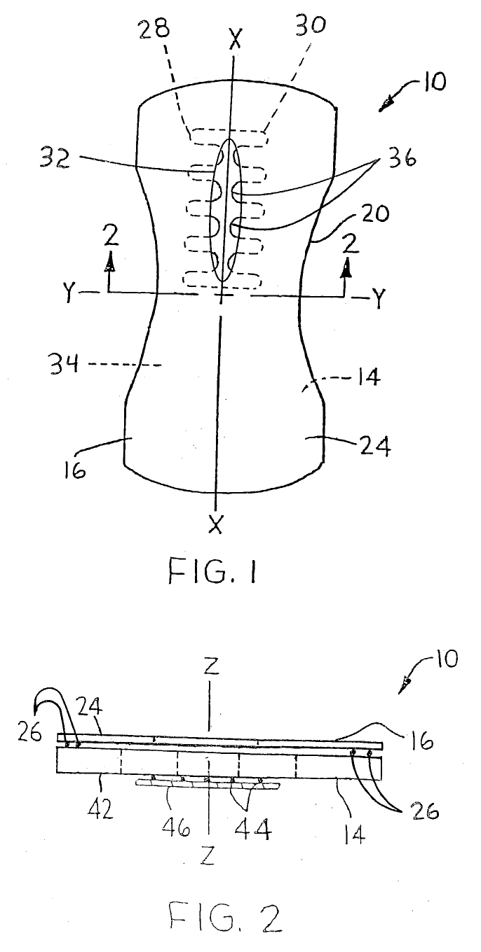

Referring to FIG. 2, the pad 14 and the body-side liner 16 can be secured together at their edges by an adhesive 26, which is desirably a construction adhesive. The adhesive 26 can be either a hot melt adhesive or a cold melt adhesive. A hot melt adhesive that works well is REXTAC® RT 2730. This construction adhesive is commercially available from Huntsman Polymers Corporation having a mailing address of 3040 Post Oak Blvd., Houston, Tex., 77056. It should be noted that the adhesive 26 could also be present at other locations within the secondary article 10.

Other methods of securing the pad 14 to the optional body-side liner 16 are known to those skilled in the art. Non-limiting examples of other attachment methods include ultrasonic bonding, pressure bonds, heat bonds, heat and pressure bonds, thermal bonds wherein one material is heated above its melting temperature and is bonded to a second material, and so forth. The pad 14 and the body-side liner 16 can also be secured together by using thread if desired.

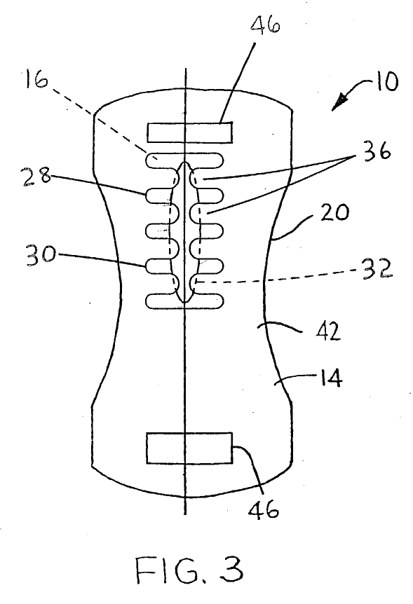

Referring to FIGS. 2 and 3, the pad 14 of the secondary article 10 has an exterior garment-facing surface 42. Secured to the garment-facing surface 42 is an optional attachment means 44, the purpose of which is to allow attachment of the secondary article 10 to the primary article 22. In other embodiments, there may be more than one attachment means 44 attached to the garment-facing surface 42. Those skilled in the art will appreciate that more than one attachment means 44 may be positioned in any number of configurations that will provide adequate attachment of the secondary article 10 to the primary absorbent article 22. For example, there may be one attachment means attached to the garment-facing surface 42 at one end of the secondary article 10 and a second attachment means attached to the garment-facing surface 42 at the opposite end of the secondary article 10.

The optional attachment means 44 is desirably one or more strips of a garment adhesive. However, the attachment means 44 can include other forms of attachment mechanisms. Other forms of attachment mechanisms that can be utilized include hook and/or loop fasteners, tape, glue, etc. A VELCRO® fastener is one form of a hook fastener that engages a loop material. VELCRO® is a registered trademark of Velcro Industries having a mailing address of 406 Brown Avenue, Manchester, N.H. 03103. When the attachment means 44 is a garment adhesive, the adhesive can be either a hot or cold melt adhesive that is sprayed, brushed, slot coated or otherwise applied onto the exterior garment-facing surface 42 of the pad 14. As one example, the garment adhesive can be applied as one or more beads, lines or strips of adhesive aligned approximately parallel to the longitudinal axis x-x, although other directions will work as well. Desirably, the garment adhesive is a hot melt adhesive. Garment adhesive is commercially available from several vendors. One such vendor is National Starch and Chemical Company having an office at 10 Finderne Avenue, Bridgewater, N.J. 08807.

When a hook and loop fastener is used as the optional attachment means 44, the hook portion can be secured to a portion of the pad 14 and the loop portion can be secured to a portion of the primary absorbent article 22 or vice versa. It should also be noted that some materials, like spunbond materials, can serve the same function as a loop material and therefore a separate patch of loop material may not have to be secured opposite to the hook material. For example, if a patch of hook material is secured to the pad 14, the primary absorbent article 22 may not be required to have a separate patch of loop material secured to it.

As mentioned above, the pad 14 has an exterior garment-facing surface 42 and a portion of this exterior surface 42 will contact the primary absorbent article 22. The portion of the exterior garment-facing surface 42 that will contact the primary absorbent article 22 can be formed to have a high coefficient of friction making it a non-skid surface. For example, the exterior garment-facing surface 42 can consist of a roughened surface, a treated surface or be made from a non-skid material. The roughened, treated or non-skid surface will provide a physical attachment to the primary absorbent article 22. Another way of stating this is to say that the non-skid portion of the exterior surface 42 serves a similar function as the attachment means 44.

The attachment means 44 can be protected from contamination by a releasable or removable peel strip 46. The peel strip 46 is designed to be removed by the consumer just prior to positioning and attaching the secondary article 10 to the crotch portion of the primary absorbent article 22. The releasable peel strip 46 is generally slightly larger in overall dimensions when compared to the attachment means 44 so as to enable the secondary article 10 to be manufactured at high speeds. By “high speeds” it is meant the ability to manufacture at a speed of more than 200 secondary absorbent articles per minute. The peel strip 46 can be a white Kraft paper, coated on one side so that it can be easily released from the attachment means 44.

In accordance with one embodiment of this invention, the secondary article 10 optionally may include a pair of containment flaps that are configured to provide a barrier to the lateral flow of body exudates. The containment flaps may be located along the laterally opposing side edges of the secondary article 10 adjacent the side edges of the pad 14. Each containment flap typically defines an unattached edge that is configured to maintain an upright, perpendicular configuration in at least the crotch region of the secondary article 10 to form a seal against the body of the wearer. Each containment flap may extend longitudinally along at least a portion of a length of the absorbent core 16. Desirably, each containment flap extends along substantially the entire length of the pad 14 to better contain the body exudates. Such containment flaps are generally well known to those skilled in the art. For example, suitable constructions and arrangements for containment flaps are described in Enloe, U.S. Pat. No. 4,704,116, the entire contents of this patent being incorporated herein by reference. In another embodiment, the edges of the optional body-side liner 16 may be elasticized to form a containment flap as described above.

Referring now to FIGS. 5 and 6, a primary absorbent article 22 is shown having a back waist region 48, a front waist region 45, and a crotch portion 64 bordered by a pair of leg cuffs 50 and 52. The front waist region 45 includes the portion of the primary absorbent article 22 that when worn, is positioned on the front of the wearer while the back waist region 48 includes the portion of the primary absorbent article 22 that when worn is positioned on the back of the wearer. The crotch portion 64 of the primary absorbent article 22 includes the portion of the primary absorbent article 22 that when worn is positioned between the legs of the wearer and covers the lower torso of the wearer. Each of the pair of leg cuffs 50 and 52 can be elasticized, if desired, by incorporating one or more strands of elastic, 54 and 56 respectively. The primary absorbent article 22 also has a liquid permeable body-side liner 58, a liquid-impermeable outercover 60, and an absorbent core 62 positioned therebetween. Desirably, the absorbent core 62 is completely enclosed between the body-side liner 58 and the outercover 60. The body-side liner 58 is designed to allow rapid intake of body fluid. The body-side liner 58 can be made from the same types of materials as were described above for the optional body-side liner 16 in the secondary article 10. The body-side liner 58 can be formed from a woven material, nonwoven material, finely perforated film, net material, and so forth. Suitable materials include bonded carded webs of polyester, polypropylene, polyethylene, nylon or other heat-bondable fibers. Other polyolefins, such as copolymers of polypropylene and polyethylene, and linear low-density polyethylene also work well.

The liquid-impermeable outercover 60 functions to prevent body fluid from passing therethrough. The liquid-impermeable outercover 60 can be made from a micro-embossed polymeric film, such as polyethylene or polypropylene, or it can be made from multicomponent films. A desired material is a polyethylene film having a thickness of less than about 0.08 mm. Composite materials formed from a polymer film and a nonwoven fabric material can also be used. The composite sheets may be formed by extrusion of the polymer film onto a web of spunbond material to form an integral sheet. This material is desirable because the outer fabric surface is not irritating to the skin of the wearer and has a cushioned feel.

The primary absorbent article 22 is depicted as having a pair of refastenable ears 66 and 68 and a fastening zone 65. The article 22 can be positioned around the torso of the wearer and the refastenable ears 66 and 68 fastened to the fastening zone 65. Such a design is advantageous in allowing for tightening or loosening the primary absorbent article 22 around the waist of the wearer.

It should be noted that the primary absorbent article 22 could be in the form of a pant product, brief product, undergarment, or any other absorbent article. The primary absorbent article 22 is desirably a disposable or limited use product that will be discarded after a single use. Furthermore, the primary absorbent article 22 can be an absorbent article that has a pocket or fold for containing a disposable insert or liner. Any and all such absorbent articles 22 are capable of being used in conjunction with the secondary article 10.

In use, the secondary article 10 is secured to at least a portion of the body-side liner 58 in the crotch portion 64 of the primary absorbent article 22 before the primary absorbent article 22 is placed on the body of the wearer. For the embodiment depicted in FIGS. 1-3, the releasable peel strip 46 is removed from the secondary article 10, exposing the attachment means 44. The crotch portion 20 of secondary article 10 is then placed or aligned over at least a portion of the crotch portion 64 of the primary absorbent article 22. Alternatively, the secondary article 10 may be placed in the area of the primary absorbent article 22 where it is most likely to be to collect and retain the solid wastes in the internal void 28 of the pad 14. The secondary article 10 is then pressed against the primary absorbent article 22 to secure the attachment means 44 thereto. Alternatively, the secondary article 10 may be secured to the primary absorbent article 22 by tucking one or more outer edges of the secondary article 10 inside a pocket or fold on the bodyfacing surface of the primary absorbent article 22. The primary absorbent article 22 can then be secured around the torso of the wearer. In use, the secondary article 10 will acquire a cup shape configuration matching the crotch portion 64 of the primary absorbent article 22.

It should be noted that the purpose of the secondary article 10 is to receive and retain the solid wastes discharged by the wearer. The secondary article 10 is constructed with a liquid permeable pad 14 so as to permit the bodily fluid discharged by the wearer to pass quickly down into the primary absorbent article 22. Because the discharged bodily fluid is not absorbed into the secondary article 10, the secondary article 10 stays dry against the skin of the wearer. Because the secondary article 10 stays dry, skin wellness is promoted.

While the invention has been described in detail with respect to specific embodiments thereof, and particularly by the example described herein, it will be apparent to those skilled in the art that various alterations, modifications and other changes may be made without departing from the spirit and scope of the present invention. It is therefore intended that all such modifications, alterations and other changes be encompassed by the following claims.

We claim:

1. A solids-entrapping secondary article comprising a liquid-permeable pad having a body-facing surface, wherein the body-facing surface of the pad defines an opening providing access to an internal void defined within the pad, the internal void being sized and positioned within the pad to collect and retain solid wastes.

2. The secondary article of claim 1 wherein the shape of the secondary article is rectangular.

3. The secondary article of claim 1 wherein the length of the secondary article is less than about 500 millimeters.

4. The secondary article of claim 1 wherein the width of the secondary article is less than about 150 millimeters.

5. The secondary article of claim 1 wherein the height of the secondary article is less than about 30 millimeters.

6. The secondary article of claim 1 wherein the pad is resilient to z-directional compression.

7. The secondary article of claim 1 wherein the pad comprises a foam.

8. The secondary article of claim 1 wherein the pad comprises crimped fibers.

9. The secondary article of claim 1 wherein the pad comprises multicomponent fibers.

10. The secondary article of claim 1 wherein the pad comprises a three-dimensional fiber network comprising compressible projections, wherein the compressible projections return substantially to their original shape after being compressed.

11. The secondary article of claim 1 wherein the pad comprises more than one layer.

12. The secondary article of claim 1 wherein the pad is substantially nonabsorbent.

13. The secondary article of claim 1 wherein the volume of the internal void defined within the pad is greater than about 5 cm³.

14. The secondary article of claim 1 wherein the cross-sectional area of the opening defined in the body-facing surface of the pad that provides access to the internal void is greater than about 2 cm².

15. The secondary article of claim 1 wherein the pad further comprises at least two fingers extending into the internal void defined within the pad.

16. The secondary article of claim 1 further comprising a liquid-permeable body-side liner wherein the body-side liner defines an opening that aligns with the opening defined in the body-facing surface of the pad to permit passage of solid waste material through the body-side liner and into the internal void of the pad.

17. The secondary article of claim 16 wherein the body-side liner is spunbond material.

18. The secondary article of claim 16 wherein the cross-sectional area of the opening defined in the body-side liner is greater than about 2 cm².

19. The secondary article of claim 16 wherein the cross-sectional area of the opening defined in the body-side liner is larger than the cross-sectional area of the opening defined in the body-facing surface of the pad.

20. The secondary article of claim 16 wherein the body-side liner and the pad are secured together at their edges.

21. The secondary article of claim 1 further comprising an attachment means adapted to attach the secondary article to a primary absorbent article.

22. A solids-entrapping secondary article for use with a primary absorbent article, the secondary article comprising a liquid-permeable pad defining an internal void, the internal void having a volume greater than about 5 cm³ and being positioned within the pad to collect and retain solid wastes.

23. The secondary article of claim 22 wherein the pad is substantially nonabsorbent.

24. The secondary article of claim 22 wherein the volume of the internal void defined within the pad is greater than about 10 cm³.

25. The secondary article of claim 22 wherein the pad further comprises at least two fingers extending into the internal void.

26. A solids-entrapping secondary article comprising:
a liquid-permeable pad having a body-facing surface, wherein the body-facing surface of the pad defines an opening providing access to an internal void defined within the pad, the internal void being sized and positioned within the pad to collect and retain solid wastes; and,
a liquid-permeable body-side liner wherein the body-side liner defines an opening that aligns with the opening defined in the body-facing surface of the pad to permit passage of solid waste material through the body-side liner and into the internal void defined within the pad.

27. The secondary article of claim 26 wherein the pad is substantially nonabsorbent.

28. The secondary article of claim 26 wherein the volume of the internal void defined within the pad is greater than about 10 cm³.

29. The secondary article of claim 26 wherein the cross-sectional area of the opening defined in the body-facing surface of the pad that provides access to the internal void is greater than about 2 cm².

30. The secondary article of claim 26 wherein the pad further comprises at least two fingers extending into the internal void.

31. An absorbent system comprising:
a primary absorbent article having a target zone for receiving waste; and,
a solids-entrapping secondary article comprising a liquid-permeable pad having a body-facing surface, wherein the body-facing surface of the pad defines an opening providing access to an internal void defined within the pad, the opening and internal void being sized to collect and retain solid wastes, and the opening and internal void being positioned within the target zone of the primary absorbent article.

32. The absorbent system of claim 31 wherein the pad is resilient to z-directional compression.

33. The absorbent system of claim 31 wherein the pad comprises a foam.

34. The absorbent system of claim 31 wherein the pad comprises crimped fibers.

35. The absorbent system of claim 31 wherein the pad comprises multicomponent fibers.

36. The absorbent system of claim 31 wherein the pad comprises a three-dimensional fiber network comprising compressible projections, wherein the compressible projections return substantially to their original shape after being compressed.

37. The absorbent system of claim 31 wherein the pad comprises more than one layer.

38. The absorbent system of claim 31 wherein the pad is substantially nonabsorbent.

39. The absorbent system of claim 31 wherein the volume of the internal void defined within the pad is greater than about 5 cm³.

40. The absorbent system of claim 31 wherein the cross-sectional area of the opening defined in the body-facing surface of the pad that provides access to the internal void is greater than about 2 cm².

41. The absorbent system of claim 31 wherein the pad further comprises at least two fingers extending into the internal void.

42. The absorbent system of claim 31 further comprising a liquid-permeable body-side liner wherein the body-side liner defines an opening that aligns with the opening defined in the body-facing surface of the pad to permit passage of solid waste material through the body-side liner and into the internal void of the pad.

43. The absorbent system of claim 42 wherein the cross-sectional area of the opening defined in the body-side liner is greater than about 2 cm².

44. The absorbent system of claim 42 wherein the cross-sectional area of the opening defined in the body-side liner is larger than the cross-sectional area of the opening defined in the body-facing surface of the pad.

45. The absorbent system of claim 31 further comprising an attachment means attaching the solids-entrapping secondary article to the primary absorbent article.

46. The absorbent system of claim 31 wherein the secondary article is substantially the same shape as the primary absorbent article.
